(19) United States
(12) Patent Application Publication
(10) Pub. No.: US 2004/0005033 A1
(43) Pub. Date: Jan. 8, 2004

(54) Radiographic imaging cassette employing an optical transmitter

(76) Inventors: H. Keith Nishihara, Los Altos, CA (US); Gary Cantu, San Carlos, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/189,275

(22) Filed: Jul. 3, 2002

(51) Int. Cl. G03C 5/16

(52) U.S. Cl. 378/169

(57) ABSTRACT

A cassette is provided for use with a radiographic imaging system using a photo-stimulable media. The cassette comprises an optical transmitter adapted to send an optical output and a controller, wherein the optical transmitter automatically changes the optical output when so instructed by the controller. The cassette has a housing having said optical transmitter and controller, wherein the optical transmitter is positioned to be externally observable and the housing is suitable for containing the photo-stimulable media suitable for use with radiographic imaging.

The present application claims the benefit of priority from commonly assigned, co-pending U.S. patent application Ser. No. not yet assigned, (Attorney Docket No. 39315-0057) filed Jun. 26, 2002 and commonly assigned, co-pending U.S. patent application Ser. No. not yet assigned, (Attorney Docket No. 39315-0058) filed Jun. 26, 2002, which both claim priority to commonly assigned, co-pending U.S. Provisional Patent Application Ser. No. 60/301,514, filed Jun. 27, 2001. The complete disclosure of all applications listed above are incorporated herein by reference for all purposes.

### BACKGROUND OF THE INVENTION

1. Field of the Invention

This invention relates to radiographic imaging and more specifically to cassettes used in computed radiography, digital radiography, and film-based radiography.

2. Description of Related Art

The use of photo-stimulable phosphor image storage screens as a replacement for X-ray film and other sensors is well known. Phosphor image screens work by trapping individual X-ray photons in a storage layer. The latent image trapped in the screen can then be read by scanning the storage layer using a suitable wavelength excitation beam, preferably from a focused laser. The laser excitation beam causes the screen to release the latent image in the form of emitted stimulable phosphor light that is proportional to the X-ray energy applied to the screen during exposure. The emitted light is collected by an optical system and is converted into an electronic signal proportional to the emitted light. The electrical signal is then converted into a digital value and passed to a computer which generates and stores an image file. The image file can then be displayed as a representation of the original radiograph, with image enhancement software applied to augment the radiographic information.

Computed radiography systems typically use a cassette to house the phosphor imaging plate and protect the imaging plate from undesired exposure to light. For medical applications, a typical workflow involves a medical technician preparing several cassettes and then sequentially exposing the cassettes to X-rays according to the X-ray or study types ordered by a physician. Since typically there are no visible markings on the cassettes to remind the technician about which cassette gets which study type or which cassettes have already been exposed, the technicians have to be very careful about the handling of the cassettes. Accidentally using a cassette that has just been exposed or using a cassette for the wrong study type are sources of errors that cost time to correct and in some cases, require retakes of X-rays that needlessly expose a patient to additional radiation.

Although bar code stickers and radio frequency techniques have also been employed to write and read back data on the cassette, they fail to provide a sufficiently convenient means for an operator to easily determine the status of information stored on a cassette's internal memory or to determine the exposure status of the imaging plate in the cassette.

### SUMMARY OF THE INVENTION

The present invention provides systems, devices, and methods for facilitating the handling of a computer radiography cassette. Specifically, the present facilitates the workflow for radiology technicians by providing optical output or indicators conveying information about the cassette. By way of example, such readily available information would further optimize the workflow environment for radiology technicians by providing awareness of the status of cassettes they are handling, which is particularly useful when multiple cassettes and study types are required in a radiology procedure.

In one aspect of the present invention, a cassette is provided for use with a radiographic imaging system using a photo-stimulable media. The cassette comprises an optical transmitter adapted to send an optical output and a controller, wherein the optical transmitter automatically changes the optical output when so instructed by the controller. The cassette has a housing having said optical transmitter and controller, wherein the optical transmitter is positioned to be externally observable and the housing is suitable for containing the photo-stimulable media suitable for use with radiographic imaging. The housing is also configured to prevent exposure of the photo-stimulable media to external light while the media is contained in the housing, wherein the photo-stimulable media remains contained within the housing and unexposed to light during image capture.

In another aspect of the present invention, a cassette is provided for use with a radiographic imaging system. The cassette comprises an optical transmitter adapted to send an optical output. The cassette further comprises of a housing having said optical transmitter, wherein the optical transmitter is positioned to be externally observable and the housing is configured to be received by a radiographic imaging system. The optical transmitter changes said optical output after the cassette has been exposed to X-rays in the radiographic imaging system.

In a further aspect of the present invention, an apparatus is described for communicating information to and from a memory device in a cassette that employs light as the transmission medium. In other words, light may be used in some embodiments of the present invention for communicating information to and from the cassette. An advantage of this system is that physical contact with the memory storage component in the cassette is not required when reading information from, or storing information to, the memory storage system. In some embodiments, the present invention may facilitate the display of status information to a user without need for additional read and display hardware.

### BRIEF DESCRIPTION OF THE FIGURES

FIG. 1. Bottom view of the cassette showing optional solar cell and display panels.

FIG. 2A. Block diagram showing light based data transmission system, a cassette, and external read-back apparatus.

FIG. 2B. Block diagram showing a method according to the present invention.

FIG. 3A. Inset detail of cassette cross-section showing X-ray detection, data storage, and communication apparatus.

FIG. 3B. Schematic showing an X-ray detector coupled to the optical output device.

FIG. 4. Schematic showing another embodiment according to the present invention.

FIG. 5. View of a cassette according to the present invention having an optical receiver, a solar cell, and an optical transmitter.

FIG. 6. Perspective view showing a cassette having an optical transmitter.

FIG. 7. Cutaway view of a cassette processor.

FIG. 8. Perspective view of a cassette docking station for reading from or writing identification, status, or similar information on a cassette.

FIG. 9. Schematic of a system using an X-ray detector outside of the cassette.

FIG. 10. A perspective view of a cassette having an optical transmitter, the cassette for use with a digital radiographic system.

### DETAILED DESCRIPTION

In one aspect the present invention, light is advantageously used as a medium for transmitting information out from a cassette used in radiographic imaging. The information or optical output may be presented in a human readable form. Alternatively, the information or optical output may be presented in machine or computer readable form.

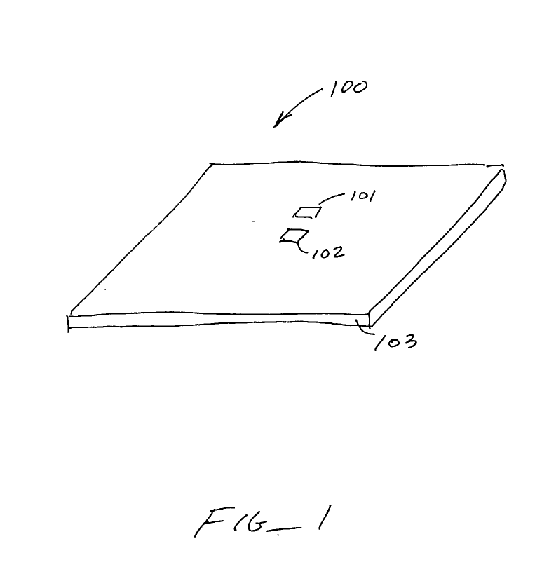

In another aspect of the present invention, light is also used as a medium for transmitting information into a cassette used in radiographic imaging. For example, information such as patient identification, cassette status, radiation strength, or the like may be transmitted to the cassette. Optionally, this light can also be employed to supply power to the storage means on a cassette. For example, in the one embodiment of FIG. 1, an optical energy receiver 101 such as a solar cell can be employed to supply power to electronics on a cassette 100. Optionally, the light can be modulated to carry data and commands into the cassette electronics. It should be understood that the optical receiver 101 may be a variety of devices as known in the art, and is not limited to, a photodiode, photosensor, or other equivalents that can receive the modulated light. While light in the visible spectrum is employed in our preferred embodiment, it is also possible and within the scope of the present invention to use wavelengths in the IR or UV ranges for providing power or communications between the cassette.

As seen in FIG. 1, information can be returned using an optical data transmitter 102 such as a display device on the cassette. In one embodiment of the present invention, this can be an LCD or other similar device that consumes relatively low power. It should be understood that the optical data transmitter 102 may also be, and is not limited to, at least one LED or other equivalent visual indicator that can provide optical output. In some embodiments, the optical output is geared to be human readable output such as text, symbols, flashes, colors, or other suitable visual indicators. In still other embodiments, the optical output is geared to be machine or computer readable output such as bar codes, Morse code flashes, optically encoded transmission signals, or other equivalent methods as may be known in the art. Both the receiver 101 and the transmitter 102 may be mounted on the housing 103 of the cassette. They may be placed on various locations on the cassette. In one embodiment, the optical transmitter or display device 102 produces a visible signal or optical output that is used to transmit data to an external receiver 240 when so commanded by an external transmitter 200. FIG. 1 shows that in this embodiment, the optical receiver 101 and optical transmitter 102 have exposed surfaces mounted on the housing 103 of the cassette. Additionally, the photo-stimulable media remains contained within the housing and unexposed to light during image capture. A system suitable for use with the present invention is described in commonly assigned U.S. Pat. Nos. 6,355,938, 6,268,613, and D450,385. The complete disclosure of all patents listed above are fully incorporated herein for all purposes.

In accordance with various preferred aspects of the invention, human readable status information may be displayed by optical transmitter 102, which may comprise but is not limited to, an LCD or similar display device, one or more LEDs or other light emitting devices. For example the LCD panel may take on one of several display states (such as being lighter or darker or flashing, etc.) when viewed by an operator in ambient light. Many possibilities exist. For example, the LCD panel 102 may appear clear if there is no patient identification (ID) information stored in the cassette memory 228; be dark if there is ID information stored in the cassette memory, flash slowly if the cassette requires erasing, and/or flash rapidly if an X-ray exposure has been detected by detector 231. It is to be understood that this example is only one of many suitable systems for displaying information about the state of the cassette.

In another example, patterns or text are displayed on the LCD. For instance, the LCD may display icons or text that indicates the study type associated with the cassette. For example, the display could indicate that an AP chest exposure is required. This could be displayed as an icon, as linear text (e.g. “AP CHEST”), or as a sequential text display that spells out the study type a letter at a time, or as a moving “times square” display where a longer message slides through a shorter text window. It may also possible to convey information through the use of different colors, for example red, green, yellow, blue LED's could be employed to indicate different cassette states. Similarly, patterns of illumination on a set of two or more indicators such as LED's arranged in a row could be used to code different states. Furthermore, patterns of flashing for example of an LCD or LED's may be used to convey information. Finally, it should be understood that combinations of one or more methods described above may be found to increase the effectiveness of the display.

It should also be understood that memory used with the cassette may nonvolatile memory so that information may be retained even if insufficient power is available. This memory may be any of a number of types familiar to those skilled in the art such as EEPROM, flash ROM, or a low drain memory capable of operating for the life of the cassette from an internal battery or from periodic charges from a solar cell

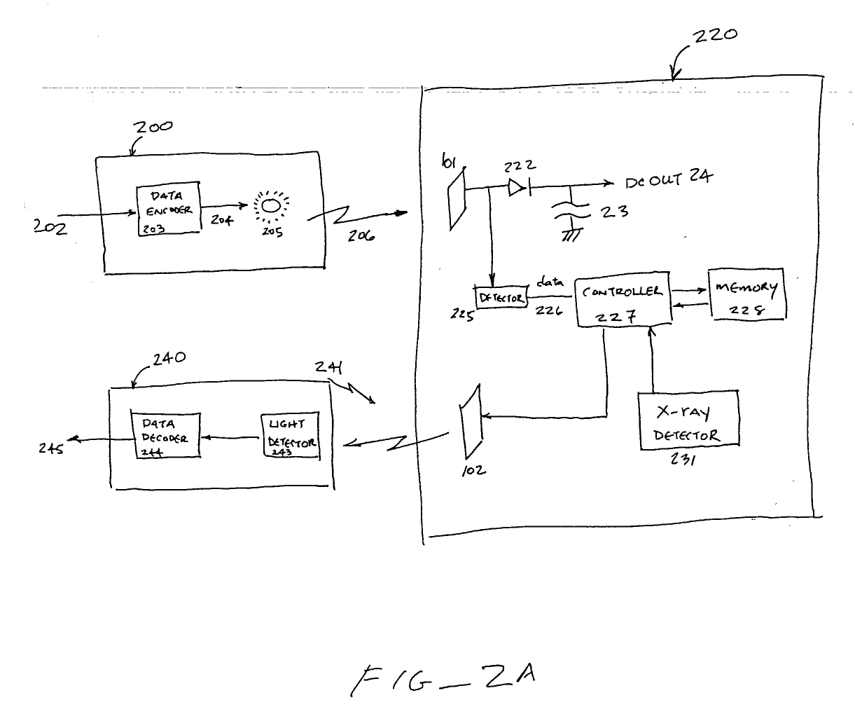

FIG. 2A shows various components of one embodiment of the present invention. An external data transmitter 200 may employ a data encoder that modulates a light source according to binary data received from an external controller 202. The modulated light source 205 illuminates a solar cell 101 on the cassette. This solar cell charges a storage element 23 such as a capacitor that is used to power the electronics on the cassette 220. With suitable design, a brief exposure to light can provide sufficient energy storage in 23 to maintain a low drain memory device for many hours. Typically the time interval between an identification operation on a cassette, its exposure, and subsequent scanning of the imaging plate contained therein is less than an hour.

In preferred aspects, if modulation is present in the light signal 206 received at the optical receiver 101, that modulation is then detected by an appropriate detector 225 and the recovered data is input to a controller 227 which parses the data stream for commands and data. As seen in FIG. 2A, the external transmitter 200 may be spaced apart from the optical receiver 101 so that data may be transmitted without physical contact between the two. Preferably, controller 227 is a microprocessor designed for very low power operation such as are used in electronic watches. Upon receiving a command to store new data, controller 227 may then store transmitted data to the memory 228. On command to retrieve stored data, the controller reads data stored on the memory 228 and displays it on the display 102 using an appropriate encoding. The optical transmitter 102 has an optical output 242. The light detector 243 picks up the encoded signal from the display 102 and data converter 244 decodes the signal and outputs the recovered data on an output port 245. This configuration advantageously allows an external device to carry out functions such as recording patient identification and or a radiological study description into the cassette's memory device for later retrieval when the X-ray exposed cassette is scanned. The exchange of light signals 206 may be executed without physical contact between the optical receiver 101 and the external transmitter 200.

In one preferred embodiment as seen in FIG. 2A, an X-ray detector 231 may also be present in the cassette. Upon exposure to an X-ray dose above a threshold set to avoid false detections, the controller 227 writes data to the memory that indicates that the cassette has been exposed. This information would typically be reset when the cassette's imaging plate is scanned and erased. It should be understood that some embodiments of the present invention may not include an X-ray detector.

Referring now to FIG. 2B, if the cassette receives input or stimuli 260, either as data loaded in through optical receiver 101 or signals from the X-ray detector 231 for example, then the change in cassette status may be reflected by a change in optical output 262 from the optical transmitter. In one embodiment, a visual indicator such as an LED will change visual states (lit versus unlit) when x-ray exposure has occurred. In the embodiment of FIG. 2A, the controller 227 regulates the optical output of the transmitter 102. Data sent to the controller 227 informing the controller of a new status of the cassette (exposed, data uploaded, media erased and ready for use, etc . . . ) will change any optical output from the optical transmitter 102.

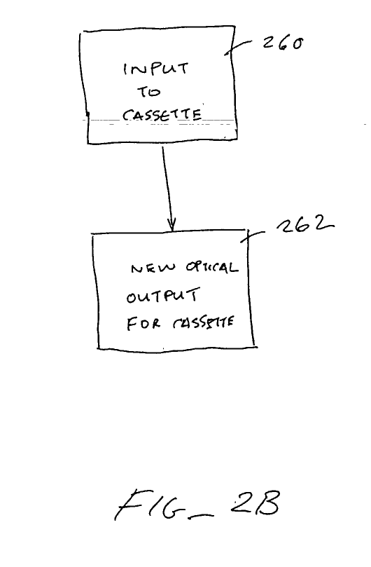

FIG. 3A shows a preferred embodiment of a X-ray detector within a cassette in cross-section. Typically, a cassette used for computed radiography applications has a top cover or lid 301 which does not significantly attenuate X-rays. Under the cover is an imaging plate 302 which receives and stores an X-ray exposure. Under the imaging plate is a lead backing 303 which serves to block X-rays that are not stopped by the imaging plate and reduce back scatter from materials behind the cassette. A hole 305 in the lead backing 303 allows X-ray energy to pass down to a detector 231 which senses the X-ray energy. In one preferred embodiment, the detector 231 is composed of several detectors arranged so that at least one is situated under the hole 305 and at least one is situated so that it is protected by the lead backing 303 or some similar shield so that a difference in detected X-ray energy can be used to determine when a proper X-ray dose level from the correct direction has occurred. A PIN diode is an example of one type of X-ray detector though any means of detecting X-rays that has a small size and low power requirements would be suitable for use with the present invention. It should be appreciated that other X-ray detectors may also be used with the present invention.

FIG. 3B shows an embodiment of the present invention where the X-ray detector is coupled to the optical transmitter or display 102. Exposing the cassette to the X-rays automatically changes the optical output that may be sent by optical transmitter to show a new status for the cassette (e.g. cassette has been exposed to X-rays). The X-ray detector may be wired to alter the optical output when the X-ray detector changes states. For example, if the optical transmitter is an LCD display screen, it may cause an icon or text to appear. If the optical transmitter is an LED, it may cause the LED to start flashing or stop flashing, or to flash at a different rate or with a different color.

A further advantage of the present invention is the ability to use the display 102 for indicating visually the status of the cassette to a human operator. In one particular embodiment, this is accomplished by detecting the presence of illumination on solar cell 101 without a modulated data signal. This situation would occur when a human operator holds the cassette so that the solar cell 101 and display panel 102 are exposed to ambient room lighting. When this lighting provides sufficient power to operate the display, controller 227 can generate a human readable display on the display panel 102. Therefore, this display can be employed to present information such as whether or not there is identification information in the cassette memory. Such display can also indicate whether or not the cassette has already been exposed. In other embodiments where battery 420 is additionally employed to power the display, a change of state in any of a number of factors such as illumination on the optical sensor 101, detection of an X-ray exposure 231, or updating of stored data in 225 could cause the display to be active for a period of time thereafter. This or a similar design would ensure that the display would be active when a human operator is likely to want to read it while preserving battery life by not operating the display at other times.

One exemplary embodiment of a human readable display employs a solid LCD panel that has three states: clear, dark, or blinking. For example, these states can be associated with cassette status information such as: NO ID INFORMATION PRESENT, ID INFORMATION PRESENT, CASSETTE NEEDS ERASING, and/or CASSETTE HAS BEEN EXPOSED.

In a more elaborate embodiment of a human readable display, an LCD with the ability to display iconic or text information may be employed. In this case, in addition to indicating the presence or absence of ID information and X-ray exposure, other information that would be useful to an operator can be displayed. For example, the type of X-ray study associated with the cassette (e.g. AP CHEST or C SPINE). In many patient procedures more than one exposure is requested.

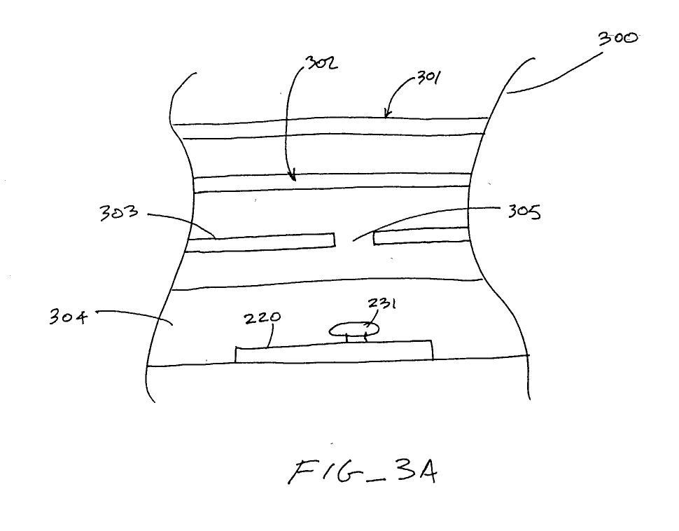

Referring now to FIG. 4, another embodiment of the present invention will now be described. The embodiment of FIG. 4 shows cassette status using at least one LED 400 as an optical transmitter. As indicated by arrow 402, a panel of LEDs may be used to provide visual indication of various conditions of the cassette. By way of example and not limited to the following, one LED when lit may indicate that the cassette is ready to be exposed. A second LED may indicate whether or not the cassette has been exposed and is ready to be read by the computer radiography device so that an X-ray image may be retrieved. A third LED may be used to cue a technician that the cassette needs to be erased, either because it has been unused for a long time and needs to be cleared or that the cassette was not erased after its most recent exposure. Alternatively, a single LED may be flashed sequentially to relay multiple messages. For example, the LED my flash twice quickly to indicate that it has been exposed. It may flash three times in a row to indicate that it needs to be erased.

As seen in FIG. 4, a controller 410 such as a MSP430F110 available from Texas Instruments or a μPD789881 ultra low-power microcontroller available from NEC is coupled to the LED 400 and a variety of other components that may be included in the cassette. Of course, other suitable controllers or microprocessors may also be used with the present invention. It should further be understood, that although all of these components may be shown for this embodiment, other embodiments of the present invention may not include every component as shown in FIG. 4. For example, the present embodiment includes a battery or similar energy storage source 420 to power a clock 422 coupled to the controller 410. The clock may be used by the controller to determine how much time has passed since the imaging plate of the cassette has been erased or last exposed. If the cassette has been in storage or idle for quite some time, it may be desirable to reformat or re-erase the imaging plate prior to usage so that any accumulated, trace X-ray, cosmic ray, self-radiation from radioactive impurities in the storage phosphor layer, or other background radiation exposures may be removed. The present embodiment also includes a counter 424 coupled to the controller 410 that counts erase cycles for the cassette or imaging plate. Data from the counter 424 or the counter 424 may be stored on memory device 430. The memory device 430 may be nonvolatile memory so that data is retained even if power to cassette electronics is lost. The memory device 430 may also store data received from data input receiver 440 connected to the controller 410. The receiver 440 may be an optical receiver such as a photodiode or it may be an electronic data port as known in the art. For example, electrical contacts on the cassette may be employed to provide serial communications using one of a number of protocols known in the art such as IIC or RS-232. The present invention may include a separate solar cell 450 to provide power to the cassette. In the present embodiment, a suitable X-ray detector 431 is also coupled to the controller 410.

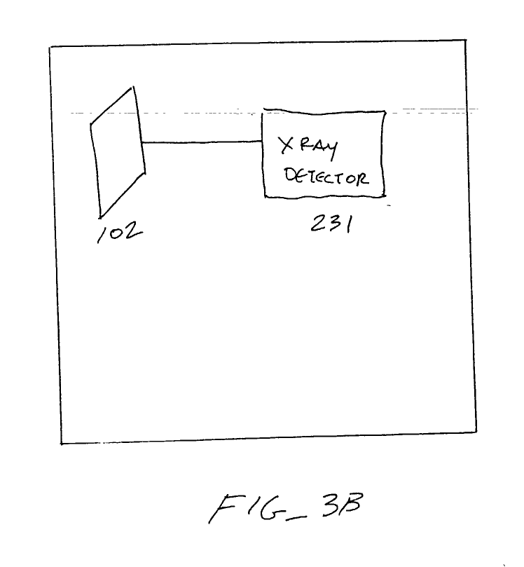

FIG. 5 shows an external view of a cassette 500 similar to that of FIG. 4. A data input receiver 440 is located on the cassette 500 as well as a solar cell 450. An optical transmitter 510 is positioned on the cassette 500 to provide optical output that may be in human recognizable or readable form or may be in computer or machine readable form. While the optical transmitter 510 is shown on the bottom face of the cassette, it may be optional in some embodiments to place it on an edge of the cassette to facilitate viewing of the display when the cassette is stacked with other cassettes or lying bottom down on a surface.

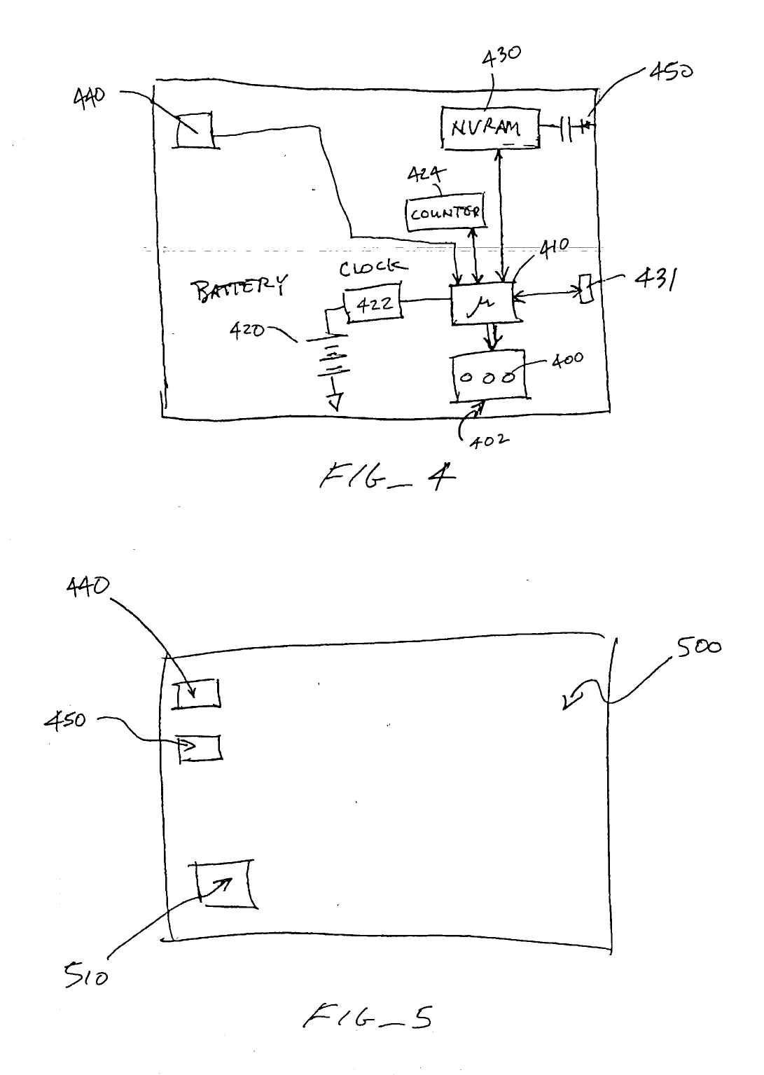

FIG. 6 shows still another embodiment of the present invention. Cassette 600 includes an optical transmitter 602 such as, but not limited to, an LCD display on a top surface of the cassette. Optionally, the cassette 600 may include a data input receiver 604 (shown in phantom) on a side surface of the cassette. The cassette 600 may include an electronic data port 606 (shown in phantom) which a plug such as a serial data connector or other electronic data connector may interface. It should be understood, that some embodiments of the present invention may not include either a data input receiver 604 or an electronic data port 606.

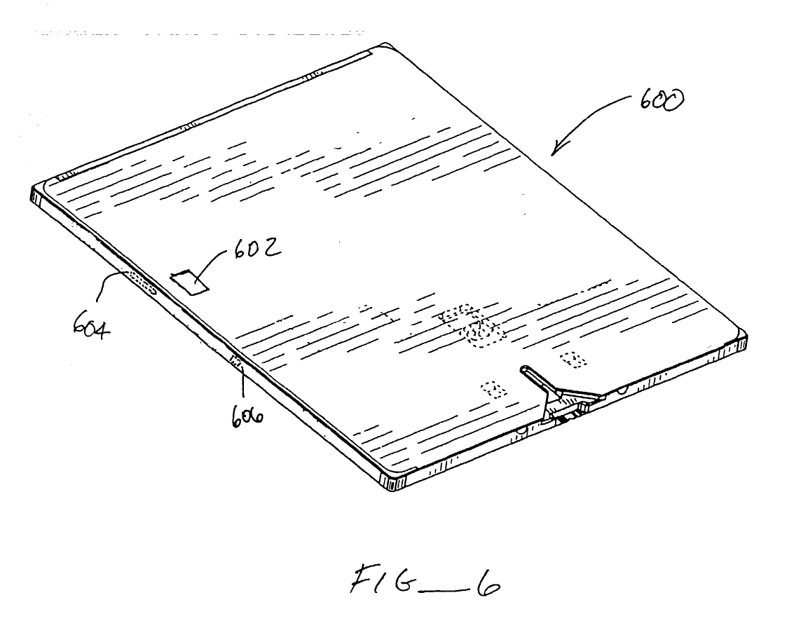

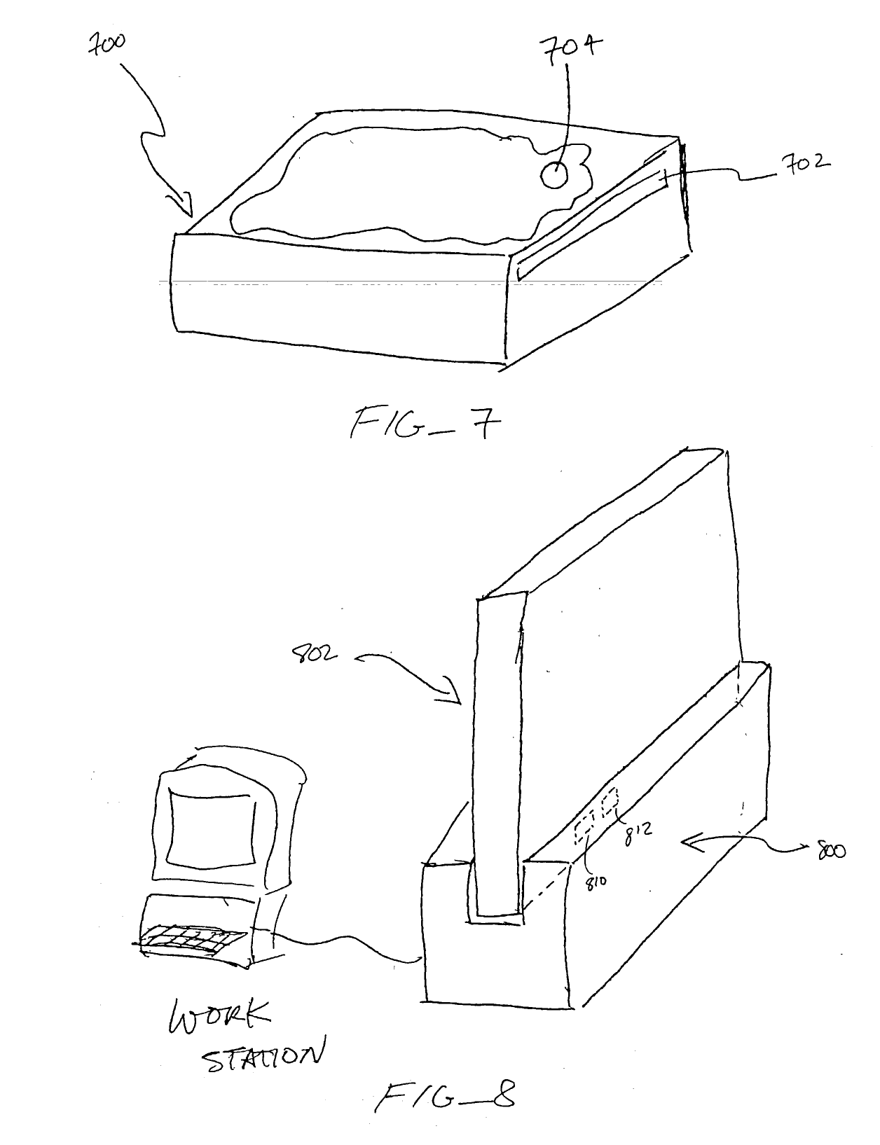

Referring now to FIGS. 7 and 8, a system for processing a cassette with an imaging plate will be described. FIG. 7 shows a cassette processor 700 having a slot 702 for receiving the cassette. A suitable processor for use with the present invention is described in U.S. Pat. Nos. 6,355,938 and 6,268,613, incorporated herein by reference. A cutaway of the top surface of the reader shows receiver 704 for reading the optical output from the cassette. Alternatively, the device 704 may be an optical transmitter for loading data onto the cassette.

FIG. 8 shows a cassette docking station 800 designed to read identification and other status information off the cassette 802 but, unlike the device of FIG. 7, does not extract the imaging plate for processing. This station 800 may be useful for sorting the cassettes prior to processing or the like when only identification information is extracted from or loaded onto the cassette 802. As seen in this embodiment, optical transmitter 810 and optical receiver 812 are shown in phantom on the cassette 802. In this embodiment, the transmitter 810 and receiver 812 are positioned to engage appropriate interfaces on the docking station 800 to allow for information exchange.

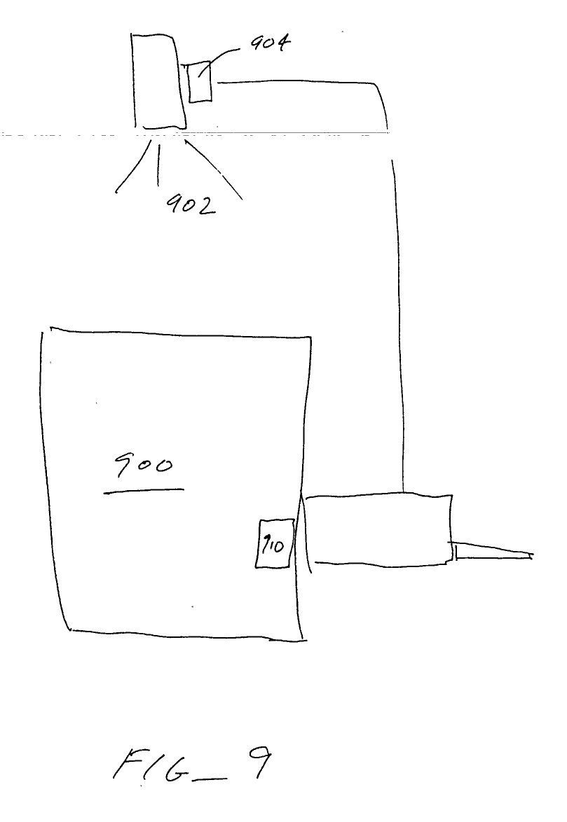

FIG. 9 shows an embodiment of the invention where the cassette 900 is exposed to X-rays or similar radiation as indicated by lines 902. A sensor 904 indicates to the radiographic imaging system that X-rays have been released and this information is transferred to the memory 910 in the cassette 900. This transfer may occur automatically, when the operator loads information into the cassette, or at anytime before the cassette is removed from the radiographic imaging system.

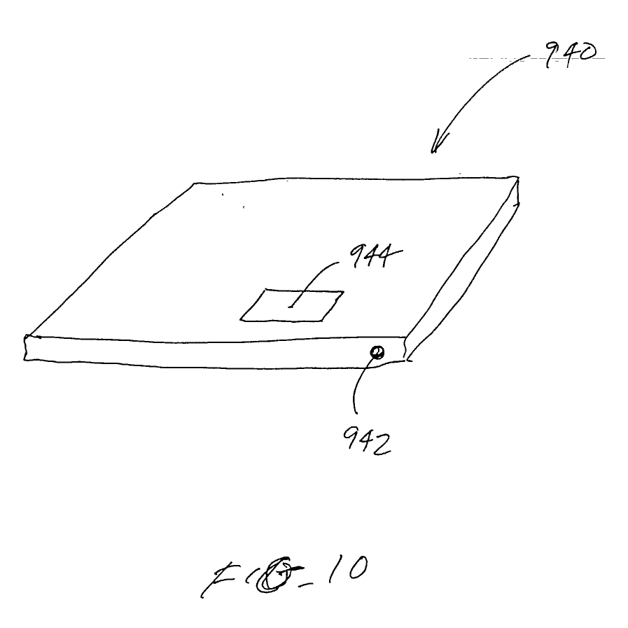

Referring now to FIG. 10, a digital radiographic system may employ a standalone cassette 940 that may be plugged into a reader to off load image data via port 942. The port 942 may be optical or electronic. A digital radiographic system using digital storage instead of film based systems may have a status display 944 on its cassettes. For example, the optical transmitter or status display may show the number of exposures taken, or list of shots required for study along with patient info described herein. Such a system may allow for multiple image captures using the same cassette.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, although we describe embodiments for computed radiography, the present invention may be widely applicable to other modalities employing cassettes such as for film based X-ray imaging or digital radiographic imaging. Furthermore, the present invention may be employed in non-medical applications where it is useful to inform a user of the status of a cassette containing some form of photo-sensitive media. Optionally, in embodiments of the present invention, the optical receiver may be some combination of a solar cell and a device capable of receiving modulated light signals, so that a single device can provide energy for the cassette electronics and handle data input. X-ray detectors may be mounted on the housing so long as they do not impair the forming of an X-ray image on the sensitive media contained in the cassette. Furthermore the X-ray detector may be designed so as not to accidentally register X-ray exposure except during the radiology procedure. The cassette housing may have slide or hinge covers (opaque, translucent, transparent, etc . . . ) to protect the display or optical transmitters or receivers. The media may be fully contained within the housing with no parts of the media exposed during image formation or capture. During processing to retrieve the image, one possible implementation is a cassette with a cover that fully opens so that the media can be scanned in place. The present invention may use low voltage batteries such as watch batteries. By way of example, batteries suitable for use with some embodiments of the present invention include silver oxide or mercury batteries with voltages between about 1.0 to 1.6 volts. Other embodiments may adapt lithium cells. The lithium used in watches are Lithium-Manganese Dioxide, and are rated at 3.0 volts. The other type of lithium cells commonly seen are Lithium-Thionyl Chloride, which are rated at 3.6 or 3.7 volts. The present application is related to commonly assigned, co-pending U.S. patent application Ser. No. 60/302,816 filed Jul. 3, 2001 and commonly assigned, co-pending PCT Patent Application Ser. No. not yet assigned, (Attorney Docket No. 39315-0056 PCT) filed Jun. 27, 2002. The complete disclosure of all applications listed above are incorporated herein by reference for all purposes. Expected variations or differences in the results are contemplated in accordance with the objects and practices of the present invention. It is intended, therefore, that the invention be defined by the scope of the claims which follow and that such claims be interpreted as broadly as is reasonable.

1. A cassette for use with a radiographic imaging system using a photo-stimulable media, the cassette comprising:
an optical transmitter adapted to send an optical output;
a controller, wherein the optical transmitter automatically changes said optical output when so instructed by the controller;
a housing having said optical transmitter and controller, wherein said optical transmitter is positioned to be externally observable, said housing suitable- for containing the photo-stimulable media suitable for use with radiographic imaging, and said housing configured to prevent exposure of the photo-stimulable media to external light while the media is contained in the housing.
wherein the photo-stimulable media remains contained within the housing and unexposed to light during image capture.

2. A cassette as in claim 1 wherein said housing is configured to receive a planar sheet of said media and not in a rolled configuration.

3. A cassette as in claim 1 wherein said housing is configured to receive media dimensioned for medical imaging and each housing only contains media for one image capturing procedure.

4. A cassette as in claim 1 wherein optical output comprises human readable output.

5. A cassette as in claim 1 wherein optical output comprises machine readable output.

6. A cassette as in claim 1 wherein said housing further comprises having an X-ray detector.

7. A cassette as in claim 1 wherein said housing further comprises having a data input receiver.

8. A cassette as in claim 1 wherein said housing further comprises having an optical receiver.

9. A cassette as in claim 8 wherein said optical receiver is configured to receive data from an external optical transmitter without physical contact between the external optical transmitter and the optical receiver.

10. A cassette as in claim 8 wherein said optical receiver comprises a photodiode.

11. A cassette as in claim 8 wherein said optical receiver comprises a solar cell.

12. A cassette as in claim 7 wherein the receiver comprises an electronic data port.

13. A cassette as in claim 1 wherein optical output comprises text.

14. A cassette as in claim 1 wherein optical output comprises a bar code.

15. A cassette as in claim 1 wherein the optical transmitter comprises at least one LED.

16. A cassette as in claim 1 wherein the optical transmitter comprises an LCD display.

17. A cassette as in claim 1 further comprising memory for storing data from the controller.

18. A cassette as in claim 1 further comprising an energy storage device powering the controller.

19. A cassette as in claim 1 further comprising a solar cell on said housing.

20. A cassette as in claim 1 further comprising a solar cell on the housing, said solar cell coupled to an energy storage device in the housing.

21. A cassette as in claim 1 further comprising an energy storage device.

22. A cassette as in claim 1 wherein said energy storage device includes at least one of the following: a capacitor, a battery, and a low voltage battery.

23. A cassette as in claim 1 further comprising a clock for tracking when the media was last erased.

24. A cassette as in claim 1 further comprising an erase cycle counter.

25. A cassette as in claim 1 further comprising a cover that fully opens so that the media can be scanned in place.

26. A cassette as in claim 1 wherein said housing has a cover adapted to fully open so that the media can be scanned in place in the housing during media processing to retrieve a captured image.

27. A cassette as in claim 1 wherein the media uses digital radiographic storage to capture images.

28. A cassette for use with a radiographic imaging system, the cassette comprising:
an optical transmitter adapted to send an optical output;
an optical receiver; and
a housing having said optical transmitter and optical receiver, wherein said optical transmitter is positioned to be externally observable, said housing suitable for containing the photo-stimulable media suitable for use with radiographic imaging, and said housing configured to prevent exposure of the photo-stimulable media to external light while the media is contained in the housing;
wherein the photo-stimulable media remains contained within the housing and unexposed to light during image capture.

29. A cassette as in claim 28 wherein said housing is configured to receive a planar sheet of said media and not in a rolled configuration.

30. A cassette as in claim 28 wherein said housing is configured to receive media dimensioned for medical imaging and each housing only contains media for one image capturing procedure.

31. A cassette as in claim 28 wherein optical output comprises human readable output.

32. A cassette as in claim 28 wherein optical output comprises machine readable output.

33. A cassette as in claim 28 wherein said housing further comprises having an X-ray detector.

34. A cassette as in claim 28 wherein said housing further comprises having a data input receiver.

35. A cassette as in claim 28 wherein said optical receiver is configured to receive data from an external optical transmitter without physical contact between the external optical transmitter and the optical receiver.

36. A cassette as in claim 28 wherein said optical receiver comprises a photodiode.

37. A cassette as in claim 28 wherein said optical receiver comprises a solar cell.

38. A cassette as in claim 28 wherein optical output comprises text.

39. A cassette as in claim 28 wherein optical output comprises a bar code.

40. A cassette as in claim 28 wherein the optical transmitter comprises at least one LED.

41. A cassette as in claim 28 wherein the optical transmitter comprises an LCD display.

42. A cassette as in claim 28 further comprising memory for storing data from the controller.

43. A cassette as in claim 28 further comprising an energy storage device powering the controller.

44. A cassette as in claim 28 further comprising a solar cell on said housing.

45. A cassette as in claim 28 further comprising a solar cell on the housing, said solar cell coupled to an energy storage device in the housing.

46. A cassette as in claim 28 further comprising an energy storage device.
A cassette as in claim 28 wherein said energy storage device includes at least one of the following: a capacitor, a battery, and a low voltage battery.

47. A cassette as in claim 28 further comprising a clock for tracking when the media was last erased.

48. A cassette as in claim 28 further comprising an erase cycle counter.

49. A cassette as in claim 28 wherein the media uses digital radiographic storage to capture images.

50. A cassette for use with a radiographic imaging system, the cassette comprising:
means for providing optical output indicating status of the cassette;
a housing having said means, said means positioned to be externally observable, configured to prevent exposure of the photo-stimulable imaging media to external light while the media is fully contained in the housing.
wherein the photo-stimulable media remains contained within the housing and unexposed to light during image capture.

51. A method comprising:
using a cassette having an optical transmitter adapted to send an optical output;
sending data to the controller informing the controller of a new status in the cassette;
changing the optical output of the optical transmitter to show the new status of the cassette.

52. A method as in claim 51 further comprising exposing the cassette to X-rays.

53. A method as in claim 51 further comprising automatically changing the optical output.

54. A method comprising:
using light to communicate information to and from a cassette having at least an optical transmitter adapted to send an optical output, said cassette suitable for containing the photo-stimulable media, wherein said optical transmitter is positioned to be externally observable, said housing suitable for containing the photo-stimulable media suitable for use with radiographic imaging, and said housing configured to prevent exposure of the photo-stimulable media to external light while the media is contained in the housing, wherein the photo-stimulable media remains contained within the housing and unexposed to light during image capture.

55. A method as in claim 54 further comprising using light to send energy to energy storage device in the cassette.

56. A system for use with processing photo-stimulable medium, the system comprising:
a cassette having an optical receiver and an optical transmitter, the cassette suitable to contain the photo stimulable media;
a data access apparatus positionable to transmit optical signals to the optical receiver of the cassette; and
a data read back apparatus positionable to receive optical signals from the optical transmitter of the cassette.
